(19) United States
(12) Patent Application Publication
(10) Pub. No.: US 2026/0258682 A1
(43) Pub. Date: Sep. 3, 2026

(54) VEHICLE DOOR HANDLE SYSTEM

(71) Applicant: MINEBEA MITSUMI Inc., Nagano-ken (JP)

(72) Inventors: Thomas PEYNOT, Pianezza (IT); Jatin SHARMA, Pianezza (IT); Piyush BHALLA, Pianezza (IT)

(73) Assignee: MINEBEA MITSUMI Inc., Nagano-ken (JP)

(21) Appl. No.: 19/536,793

(22) Filed: Feb. 11, 2026

(30) Foreign Application Priority Data
Feb. 28, 2025 (EP) 251609723

(51) Int. Cl. E05B 85/16; E05B 85/12

(52) U.S. Cl. CPC E05B 85/16; E05B 85/12

(57) ABSTRACT

A vehicle door handle system includes a wing handle movable between a retracted position and a deployed position. In the retracted position, the wing handle can be retracted in a vehicle door, and in the deployed position, the wing handle can protrude outwardly with respect to the vehicle door. The vehicle door handle system further includes an actuator configured to cause an intermediate piece to move in translation between the retracted position and an intermediate extended position and to move in rotation between the intermediate extended position and the deployed position. The intermediate piece is fixed to the wing handle and includes bearing members preventing the wing handle from rotating when the wing handle is in the deployed position.

### CROSS-REFERENCE TO RELATED APPLICATIONS

This application claims priority to and the benefit of EP 25160972.3 filed on February 28, 2025. The disclosure of the above application is incorporated herein by reference.

### FIELD

The present disclosure relates to door handles for motor vehicles, and more particularly relates to wing handles.

### BACKGROUND

The statements in this section merely provide background information related to the present disclosure and may not constitute prior art.

Wing handles have a generally flat design and an elongated shape and are arranged aligned with a window lower belt of the vehicle door. Known wing handles protrude outwardly and generate air flow turbulences that may reduce vehicle autonomy, by increasing fuel consumption or draining the battery faster, and may increase aerodynamic noise, which is especially relevant for electrical vehicles. As being in constant protrusion with respect to the vehicle door, known wing handles also create a design disruption, which may be considered unsightly.

In addition, vehicle doors generally have a tapered profile from bottom to top, whereby room within the vehicle door may be insufficient to incorporate the operating mechanism of a wing handle.

Thus, there is a need for a compact vehicle door handle system that possibly does not protrude outwardly, while being adaptable to a broad number of implementations and vehicle designs. For a better user experience, it is also desirable that the handle is free from any play when grasped by the user.

### SUMMARY

This section provides a general summary of the disclosure and is not a comprehensive disclosure of its full scope or all of its features.

The present disclosure relates to a vehicle door handle system comprising a wing handle movable between a retracted position and a deployed position, wherein: in the retracted position, the wing handle is configured to be at least partially retracted in a vehicle door, in the deployed position, the wing handle is configured to be protruding outwardly with respect to the vehicle door, the vehicle door handle system comprises an actuator configured to cause the wing handle to move between the retracted position and the deployed position, the movement of the wing handle between the retracted position and the deployed position comprising a translation movement between the retracted position and an intermediate extended position and a rotation movement between the intermediate extended position and the deployed position, and the movements of the wing handle are controlled by the actuator by means of an intermediate piece fixed to the wing handle and comprising bearing members preventing the wing handle from rotating when the wing handle is in the deployed position.

In this manner, the wing handle has a fixed deployed position without play when the user grasps handle.

According to an embodiment, the door handle system comprises a bracket piece housing the intermediate piece, the intermediate piece comprising pivot pins about which the wing handle rotates between the intermediate extended position and the deployed position, the bearing members being formed around the pivot pins and cooperating with the bracket piece to prevent the wing handle from rotating when the wing handle is in the deployed position.

The provision of such pivot pins enables to easily control the rotation movement of the handle and provide the bearing members.

According to an embodiment, the pivot pins are maintained in oblong openings formed in the bracket piece to enable the translation movement of the intermediate piece, the bearing members bearing on portions of the bracket piece around the oblong openings.

The provision of such oblong openings makes the control of the translation movement of the handle and the provision of the bearing members easier.

According to an embodiment, the intermediate piece comprises guiding pins which slidingly cooperate with cam surfaces formed in the bracket piece to guide the wing handle during its translation movement between the retracted position and an intermediate extended position and during its rotation movement between the intermediate extended position and the deployed position.

The provision of such cam surfaces enables a precise control of the movement of the handle between the retracted position and the deployed position.

According to an embodiment, the door handle system further comprises a link arm slidingly mounted in the bracket piece, the actuator being configured to cause the link arm to move in translation with respect to the bracket piece and to push the intermediate piece, so as to move the wing handle from the retracted position to the deployed position.

The provision of such a link arm enables the use of a rotary actuator.

According to an embodiment, the door handle system further comprises a biasing element for pulling the intermediate piece from the deployed position to the retracted position when the actuator is controlled to move the wing handle from the deployed position to the retracted position.

The provision of such a biasing element, for example a spring, simplifies the coupling between the actuator and the intermediate piece.

According to an embodiment, in the retracted position, an outer surface of the wing handle is configured to be flush with an outer surface of an adjacent window lower belt of a vehicle door, and in the deployed position, the wing handle is configured to be protruding outwardly with respect to the outer surface of the window lower belt.

Such a flush position of the wing handle is particularly efficient to reduce air flow turbulences and provides an attractive design.

According to an embodiment, in the retracted position, an outer surface of the wing handle is configured to be flush with an outer surface of a vehicle door, and in the deployed position, the wing handle is configured to be protruding outwardly with respect to the outer surface of the vehicle door.

Such a flush position of the wing handle is particularly efficient to reduce air flow turbulences and provides an attractive design.

Embodiments may also relate to a vehicle door comprising a vehicle door handle system as above-defined, the vehicle door comprising a window lower belt, an outer surface of the wing handle being configured to be flush with an outer surface of the window lower belt in the retracted position, the wing handle being configured to be protruding outwardly with respect to the outer surface of the window lower belt in the deployed position.

Embodiments may also relate to a vehicle comprising one or more vehicle doors as above-defined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The foregoing and other purposes, features, aspects and advantages of the present disclosure will become apparent from the following detailed description of embodiments, given by way of illustration and not limitation, with reference to the accompanying drawings, in which the same reference refer to similar elements or to elements having similar functions, and in which:

FIG. 1 is a schematic perspective view of a part of two side doors of a vehicle, according to an embodiment;

FIG. 2 is a perspective side view of a vehicle door handle system, according to an embodiment;

FIG. 3 is a front view of the door handle system, according to an embodiment;

FIG. 4 is a perspective front view of the vehicle door handle system, with a fixed bracket piece being removed;

FIG. 5 is a perspective rear view of the wing handle, according to an embodiment;

FIGS. 6A, 6B and 6C are side views of the door handle system, respectively in a retracted position, an extended position and a deployed of the handle, according to an embodiment;

FIGS. 7A, 7B and 7C are front views of the door handle system, respectively in the retracted position and the deployed position of the handle, according to an embodiment;

FIG. 8 is a cross-sectional side view of the door handle system in the deployed position, according to an embodiment;

FIGS. 9A and 9B are side perspective views of an intermediate piece of the door handle system, according to an embodiment;

FIG. 10 is a perspective side view of the handle and the intermediate piece, according to an embodiment;

FIGS. 11A and 11B are cross-sectional side views of the door handle system in the deployed and retracted positions, according to another embodiment.

FIG. 12 is a top view of the door handle system in the deployed position, according to an embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

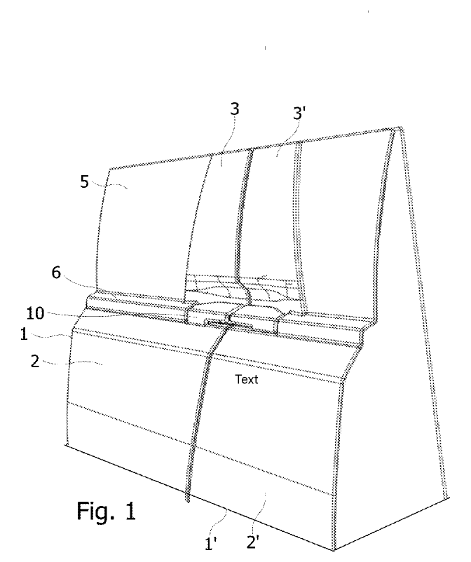

FIG. 1 shows a side part of a vehicle including pars of side vehicle doors 1, 1’. Each door 1, 1’ as shown comprises a door panel 2, 2’, a window 5, 5’, a window lower belt 6, 6’ and a handle 10, 10’, and possibly a B-pillar 3, 3’. The handles 10, 10’ are shown in a retracted position. In this position, each handle 10, 10’ is mounted in its respective vehicle door such that an outer surface 10a of the handle is flush with an outer surface of the window lower belt 6, 6’ of the respective vehicle door.

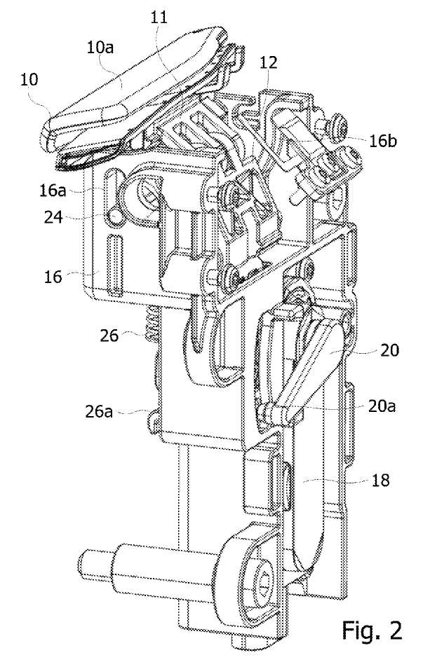

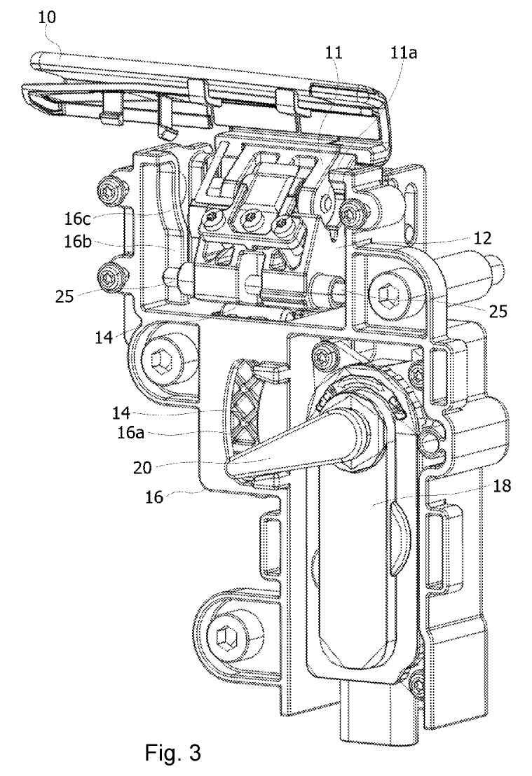

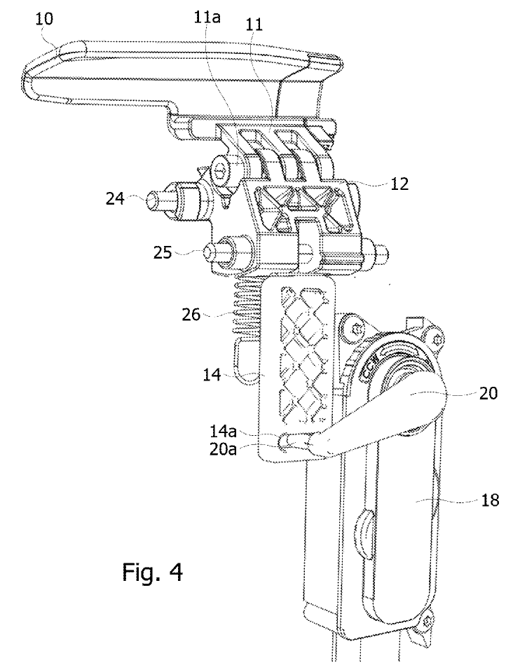

FIGS. 2, 3 and 4 show a handle system coupled to the handle 10. The handle 10 is associated with an attachment portion 11 which is fixed by a fixing element 11a such as a screw to an intermediate piece 12. The intermediate piece 12 comprises a pivot pin 24 and a guiding pin 25 parallel to the fixing element 11a. The intermediate piece 12 is mounted so as to be translationally and rotationally movable in a bracket piece 16. The bracket piece 16 also houses an actuator 18 coupled to a pivoting lever 20 for translating a link arm 14 bearing on the intermediate piece 12. The link arm 14 is slidingly housed in the bracket piece 16. The lever 20 is coupled with the link arm 14 by means of a pin 20a extending perpendicularly at a free end of the lever 20 and engaged in a slot 14a formed in the link arm 14. A biasing element 26, such as a spring, having an end fixed to the bracket piece 16 pulls and maintains the intermediate piece 12 against the link arm 14.

The bracket piece 16 comprises two opposite oblong openings 16a receiving a respective end of the pivot pin 24 of the intermediate piece 12. The bracket piece 16 further comprises two parallel cam surfaces on which ends of the guiding pin 25 of the intermediate piece 12 slide. Each of the cam surfaces comprises a linear part 16b and a curved part 16c.

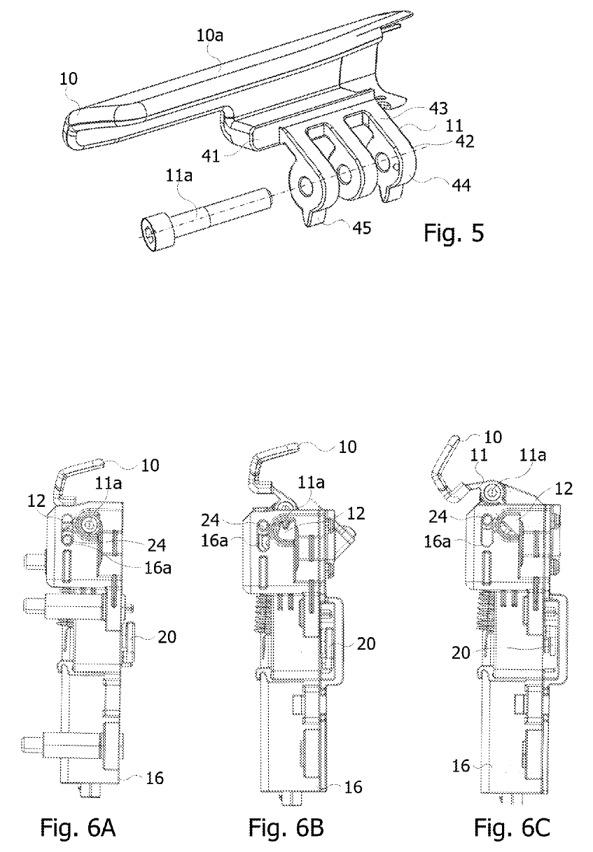

FIG. 5 shows the wing handle 10 with its attachment portion 11 and the fixing element 11a. The outer surface 10a of the handle 10 is provided to be an external surface of the vehicle, facing outwardly. The outer surface 10a may thus be visible to a vehicle user, and contribute to the general design of the vehicle. The outer surface 10a may be flat, or may have a bent shape. In the illustrated embodiment, the outer surface 10a is in particular bent around a substantially longitudinal direction. Other configurations of the handle and/or shapes of the outer surface 10a are however possible.

The attachment portion 11 extends from a longitudinal rear face 41a of the handle 10. The attachment portion 11 comprises connection flanges 42 each comprising a connection leg 43 and an eyelet 44. In the example of FIG. 5, the attachment portion 11 comprises three connection flanges 42 extending from the rear face 41a. The number of connection flanges 42 may differ from three, and be for example one, or two, or more than three. At least one of the connection flanges 42 comprise a stop 45 at a distal end thereof. Each eyelet 44 is provided with a cylindrical opening 46. The openings 46 are disposed along a same axis to receive the fixing element 11a.

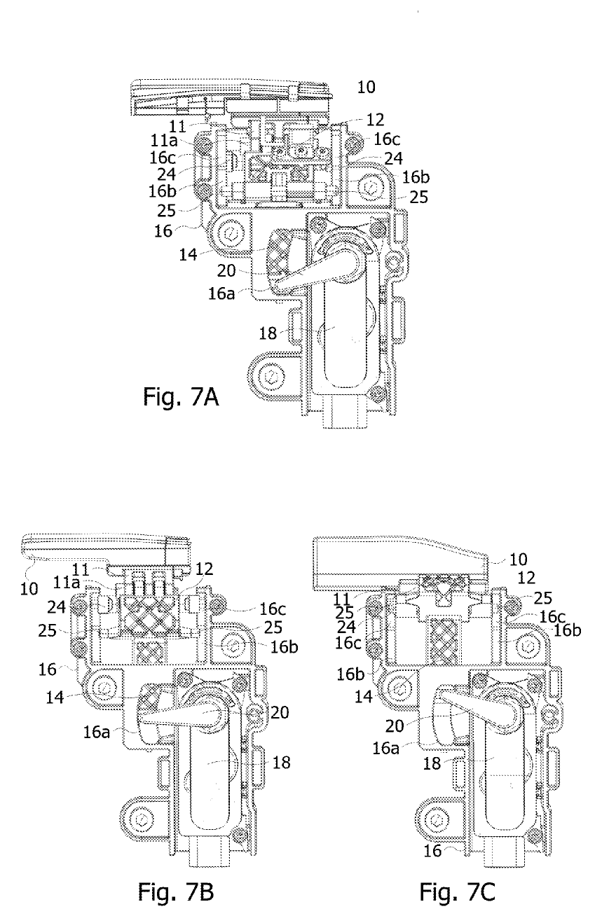

The movement of the handle 10 is illustrated in FIGS. 6A, 6B, 6C and FIGS. 7A, 7B, 7C. FIGS. 6A, 7A show the handle 10 in a retracted (and lowest) position, also shown in FIG. 1. In this position, the pin 20a of the lever 20 and the link arm 14 occupy their lowest position. The ends of the pivot pin 24 of the intermediate piece 12 are also in their lowest position in the openings 16a of the bracket piece 16. The spring 26 pulls the intermediate piece 12 against the link arm 14. On the vehicle door 1, 1’, the outer surface 10a of the wing handle 10, 10’ in the retracted position is flush with an outer surface of the adjacent window lower belt 6, 6’. More precisely, these outer surfaces 7 are aligned with each other towards a front of the vehicle. In other words, the wing handle 10, 10’ in the retracted position is comprised within a geometrical envelope defined by the outer profile of the adjacent window lower belt 6, 6’.

FIGS. 6B and 7B show the handle 10 in an extended position. To reach this position from the retracted position, the actuator 20 rotates the lever 20 to move the pin 20a from its lowest position to a middle position. During this movement of the pin 20a, the link arm 14 is moved in translation and pushes the intermediate piece 12 upwards against the force exerted by the spring 26 until the ends of the pivot pin 24 reach the upper end of the openings 16a, whereas the guiding pins 25 slide along the linear part 16b of the cam surfaces, and the handle 10 with its attachment portion 11 and the fixing element 11a move upwards out of the bracket piece 16. Thus, the intermediate piece 12 and the handle 10 follow together a linear movement. In the extended position, the intermediate piece 12 can no longer move upwards since the ends of the pivot pin 24 reach the upper end of the openings 16a. The extended position is merely an intermediate position and it is not intended that the door handle system stops deploying at this intermediary position or undergoes a break in this position.

FIGS. 6C and 7C show the handle 10 in a deployed position. To reach this position from the extended position, the actuator 20 keeps rotating the lever 20 to move the pin 20a from its middle position to a highest position. During this movement of the pin 20a, the link arm 14 keeps pushing upwards the intermediate piece 12 which is blocked in translation by the pivot pin 24. During this movement of the link arm 14, the guiding pin 25 slides along the curved part 16c of the cam surfaces, which makes the intermediate piece 12 tilt about the pivot pin 24. This rotation movement of the intermediate piece 12 is made possible due to an offset between the pins 24 and 25. The rotation of the intermediate piece 12 makes the handle 10 swivel with its attachment portion 11 to the deployed position. When the actuator 18 reaches an end position, the lever 20 stops rotating, the link arm 14 stops translating, and the intermediate piece 12 and the wing handle 10 stop rotating around the pivot pin 25. Abutments can be provided to prevent the pin 25 from pivoting too far around the pivot pin 24. At that point, the wing handle 10 is in the deployed position in which the handle protrudes outwardly and thus can be easily grasped by a user to be manually operated to open the vehicle door 1.

In order to open the vehicle 1, the user has to pull onto the wing handle 10. Upon pulling the wing handle 10, the user applies an outward force onto a grabbing portion of the handle. The wing handle 10 and the intermediate piece 12 pivot outwardly around pivot pins 24. Thereby, the intermediate piece 12 elastically deforms which deformation can be detected by a sensor such as strain gauge. The strain gauge can be configured to send a door unlocking signal to a control unit ECU (Electronic Control Unit, not illustrated) of the vehicle, whereby the vehicle door unlocks.

Once the need to operate the vehicle door 1 disappears, e.g., when the user starts the vehicle, or if the control unit in the vehicle detects that the door is closed and that the user moved away from the vehicle, the vehicle door handle system may receive a retraction order to bring the wing handle 10 back from the deployed position to the retracted position. Over such a retraction of the wing handle, the lever 20 may be moved back into its lowest position together with the link arm 14, and the biasing element 26 may pull back the intermediate piece 12.

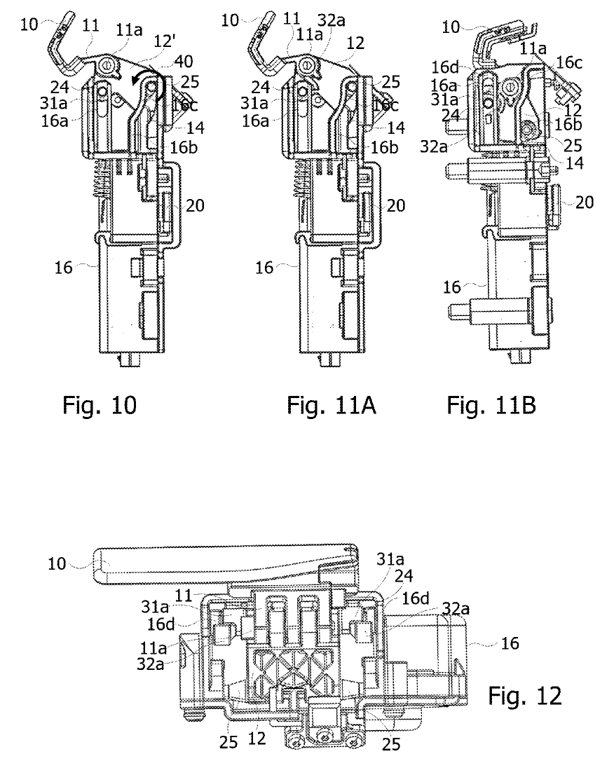

As illustrated in FIG. 10, the biasing element 26 tends to rotate the handle 10 downwards out of its deployed position (in the direction of the arrow 40), the guiding pin 25 forming a rotation axis of the handle 10 in this position.

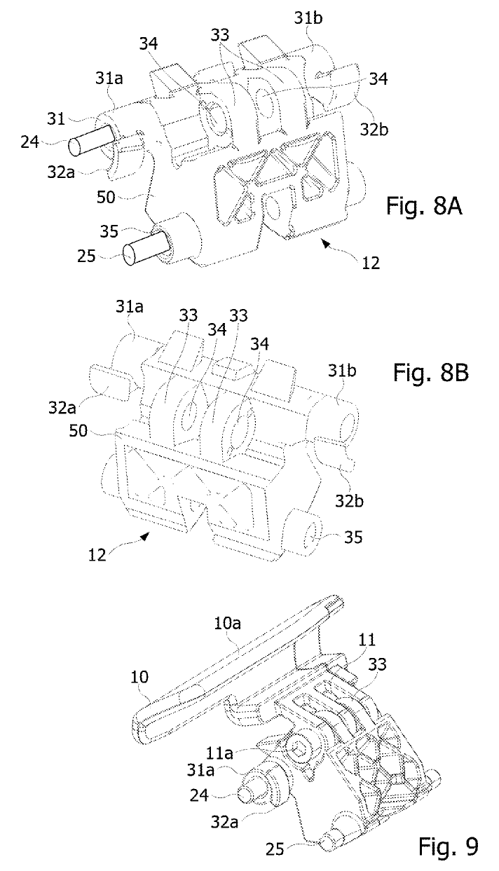

To prevent this unwanted movement of the handle 10 in the deployed position, the intermediate piece 12 has a particular shape illustrated in FIGS. 8A, 8B and 9. In FIGS. 8A, 8B and 9, the intermediate piece 12 has a body 50 comprising channels 31, 35 for receiving the pins 24, 25, and flanges 33 each provided with a cylindrical opening 34 for receiving the axis 10. The channels 31, 35 and the openings 34 have parallel longitudinal axes. The channel 31 receiving the pivot pin 24 has two opposite ends each comprising a cylindrical extension 31a, 31b extending along the pivot pin 24. Each extension 31a, 31b has a bearing member 32a, 32b protruding from an external face of each extension 31a, 31b.

As illustrated in FIGS. 11A and 12 in which the handle 10 is in its deployed position, each of the bearing members 32a, 32b bears on a portion 16d of the bracket piece 16 around each of the oblong openings 16a. Thus, the bearing members 32a, 32b prevent the rotation of the handle 10 around the guiding pin 25.

As illustrated by FIG. 11B in which the handle is in its retracted position, each of the bearing members 32a, 32b and the bracket piece 16 have cooperating shapes that do not prevent the handle from moving between the retracted position and the extended position and further the deployed position.

The above description of various embodiments is provided for purpose of description to one of ordinary skills in the related art. It is not intended to be exhaustive or to limit the scope of the present disclosure solely to the disclosed embodiments. Numerous alternatives or variations to the present disclosure will be apparent to those of ordinary skills in the related art. Accordingly, while some alternatives or embodiments have been presented specifically, other embodiments will be apparent or easily developed by those of ordinary skills in the related art within the scope defined by the appended claims. Limitations in the appended claims should be interpreted broadly based on the language used in the claims and such limitations should not be restricted to the specific examples described above.

In this respect, it is apparent to those of ordinary skills in the related art that the previously described translation and rotation movements of the wing handle can be obtained with other structures as those disclosed above of the wing handle system and the wing handle. More particularly, the intermediate piece can have other shapes and does not necessarily have pivot pins and guiding pins. For example, the intermediate piece can only have guiding pins cooperating with grooves having a rectilinear portion for the translational movement of the wing handle and a curved portion for the rotational movement thereof. In this example, the wing handle can also have play in the deployed position. Other means for obtaining the movement of the wing handle may be easily imagined by those of ordinary skills.

In addition, the actuator 18 can be a translational actuator directly coupled with the intermediate piece 12 such that the link arm 14 is not necessary. Further, the intermediate piece 12 can further be coupled with the link arm 14 or the actuator 18, such that the biasing member 26 is not necessary.

Further, the wing handle is not necessarily flush with a window lower belt of the vehicle door, but can protrude from the vehicle door even in the retracted position. In addition, the wing handle can be mounted to be flush with the vehicle door panel 2, 2’.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle door handle system comprising a wing handle movable between a retracted position and a deployed position, wherein:
in the retracted position, the wing handle is configured to be at least partially retracted in a vehicle door,
in the deployed position, the wing handle is configured to be protruding outwardly with respect to the vehicle door,
the vehicle door handle system comprises an actuator configured to cause the wing handle to move between the retracted position and the deployed position, a movement of the wing handle between the retracted position and the deployed position comprising a translation movement between the retracted position and an intermediate extended position and a rotation movement between the intermediate extended position and the deployed position, and
movements of the wing handle are controlled by the actuator by means of an intermediate piece fixed to the wing handle and comprising bearing members preventing the wing handle from rotating when the wing handle is in the deployed position.

2. The vehicle door handle system of claim 1, further comprising a bracket piece housing the intermediate piece, the intermediate piece comprising pivot pins about which the wing handle rotates between the intermediate extended position and the deployed position, the bearing members being formed around the pivot pins and cooperating with the bracket piece to prevent the wing handle from rotating when the wing handle is in the deployed position.

3. The vehicle door handle system according to claim 2, wherein the pivot pins are maintained in oblong openings formed in the bracket piece to enable the translation movement of the intermediate piece, the bearing members bearing on portions of the bracket piece around the oblong openings.

4. The vehicle door handle system according to claim 2, wherein the intermediate piece comprises guiding pins which slidingly cooperate with cam surfaces formed in the bracket piece to guide the wing handle during its translation movement between the retracted position and an intermediate extended position and during its rotation movement between the intermediate extended position and the deployed position.

5. The vehicle door handle system according to claim 2, further comprising a link arm slidingly mounted in the bracket piece, the actuator being configured to cause the link arm to move in translation with respect to the bracket piece and to push the intermediate piece, so as to move the wing handle from the retracted position to the deployed position.

6. The vehicle door handle system according to claim 1, further comprising a biasing element for pulling the intermediate piece from the deployed position to the retracted position when the actuator is controlled to move the wing handle from the deployed position to the retracted position.

7. The vehicle door handle system according to claim 1, wherein:
in the retracted position, an outer surface of the wing handle is configured to be flush with an outer surface of an adjacent window lower belt of a vehicle door, and
in the deployed position, the wing handle is configured to be protruding outwardly with respect to the outer surface of the adjacent window lower belt.

8. The vehicle door handle system according to claim 1, wherein:
in the retracted position, an outer surface of the wing handle is configured to be flush with an outer surface of a vehicle door, and
in the deployed position, the wing handle is configured to be protruding outwardly with respect to the outer surface of the vehicle door.

9. A vehicle door comprising a vehicle door handle system according to claim 1, the vehicle door comprising a window lower belt, an outer surface of the wing handle being configured to be flush with an outer surface of the window lower belt in the retracted position, the wing handle being configured to be protruding outwardly with respect to the outer surface of the window lower belt in the deployed position.

10. A vehicle comprising one or more vehicle doors according to claim 9.
